(19) United States
(12) Patent Application Publication
(10) Pub. No.: US 2011/0243800 A1
(43) Pub. Date: Oct. 6, 2011

(54) FLUIDIZED-BED REACTOR AND INSERT FOR SAID FLUIDIZED-BED REACTOR

(76) Inventors: Georg Gallmetzer, Munchen (DE); Matthias Hofmeister, Pfaffenhofen (DE); Michael Hofmeister, Rinchnach (DE); Martin Kröner, Munchen (DE)

(21) Appl. No.: 13/123,483

(22) PCT Filed: Oct. 7, 2009
(86) PCT No.: PCT/EP09/63057

§ 371 Date: Jun. 17, 2011

(30) Foreign Application Priority Data
Oct. 10, 2008 (DE) 10 2008 051 161.7

(51) Int. Cl. B01J 8/18

(52) U.S. Cl. 422/146; 422/139

(57) ABSTRACT

The invention relates to a fluidized-bed reactor having a higher power density and to an exchangeable insert for said fluidized-bed reactor, which insert makes the higher power density possible. The supply and pre-heating of the fluidizing agent, especially air, to the fluidized bed is combined with the cooling of the reactor vessel wall owing to the preferably exchangeable insert in the fluidized-bed reactor. The “cold” fluidizing agent is guided in at least one flow channel in the metal jacket surrounding the fluidized bed and is preheated and said channel and is then injected into the fluidized bed in an appropriate location. The reactor vessel wall is cooled by pre-heating the fluidizing agent. The desired and required values for cooling the reactor vessel and the desired pre-heating of the fluidizing agent can be adjusted by suitably selecting the parameters ‘length’ and ‘volume’ of the flow channels in the insert and the flow rate of the fluidizing agent in the flow channels. The insert is used for supplying the fluidizing agent and for cooling the reactor vessel, thereby eliminating the need for a separate cooling device for the reactor vessel and for lining the reactor vessel with refractory clay. The reactor vessel according to the invention is compact, has a high power density and small thermal masses.

The invention relates to a fluidized bed reactor according to claim 1 which comprises an insert encompassing the fluidized bed for supplying fluidizing agent and cooling of the reactor vessel; it furthermore relates to a like insert according to claim 20.

Very high temperatures in the area of 900° C. are produced in reactor vessels comprising a fluidized bed and having chemical reactions unfold in them, in particular in combustion chambers with a fluidized bed combustion system and in fluidized beds for producing combustion gas by allothermal steam gasifications of carbonaceous feedstocks. In order for the reactor vessel to resist these high temperatures over prolonged periods of time, the inner walls of the combustion chamber are lined with refractory materials, in particular refractory clay. This significantly increases the thermal masses and geometrical dimensions of the combustion chamber. As an alternative, steel jacket or steel sheaths as the reactor vessel allow a more compact design but require cooling of the reactor vessel because of the high temperatures. Such cooling is typically achieved with water or steam and amounts to increased complexity.

From EP 1 187 892 B1 a like fluidized bed reactor for generating combustion gas from carbonaceous feedstocks is known, wherein combustion gas is produced in a pressurized fluidized bed gasification chamber by allothermal steam gasification from the feedstocks to be gasified. The heat required for this purpose is supplied from a fluidized bed combustion system with the aid of a thermoconducting pipe arrangement.

From DE 197 50 475 C1 a fluidized bed reactor is known, wherein cold combustion air externally flows around the reactor vessel within a cooling jacket surrounding the reactor vessel, to thereby cool the reactor vessel and in turn be pre-heated itself. The pre-heated combustion air is withdrawn from the cooling jacket at the top and supplied, in the form of hot air via an external line, to the fluidized bed from below as combustion air and fluidizing agent. The external routing of the hot air results in considerable thermal losses. As the cooling jacket merely surrounds the reactor vessel in the form of a sheath, uniform cooling of the reactor vessel is not ensured.

From U.S. Pat. No. 1,803,306 A a reactor having a reactor vessel is known. The reactor vessel comprises an exchangeable insert having a metallic jacket. In the lower area of the insert the jacket is penetrated in the radial direction by bores which open into a gas collection space beneath a perforated floor. The gas externally flows around the insert before entering the gas collection space through the bores in the jacket. If an exothermal reaction takes place inside the insert, the gas is pre-heated and the insert is cooled in this way. The non-directed flow around the insert does not achieve homogeneous cooling.

From DE 44 32 340 C1 and DE 10 2006 029 821 B3 heat exchangers are known that consist of at least two panels which are welded together and in which flow channels for a heat exchanger medium are formed by hydroforming.

Starting out from EP 1 187 892 B1, it is an object of the present invention to specify a fluidized bed reactor having a higher power density. Furthermore it is an object of the invention to specify an exchangeable insert for a like fluidized bed reactor.

This object is achieved through a fluidized bed reactor in accordance with the features of claim 1 and through an insert for a like fluidized bed reactor according to claim 20.

As a result of the—preferably exchangeable—insert in the fluidized bed reactor according to the present invention, feeding and pre-heating of the fluidizing agent, in particular air, into the fluidized bed is combined with cooling of the reactor vessel wall. The “cold” fluidizing agent is conducted in at least one flow channel in the metallic jacket enclosing the fluidized bed and is then introduced into the fluidized bed in an appropriate location. Pre-heating of the fluidizing agent results in cooling of the reactor vessel wall. An appropriate selection of the parameters of length and volume of the flow channels in the insert and of the flow velocity of the fluidizing agent in the flow channels allows to adjust the desired and required values for cooling of the reactor vessel and the desired pre-heating of the fluidizing agent. Due to the forced conduction in the flow channel running in the jacket in parallel with the jacket, homogeneous or uniform cooling of the jacket is achieved. As the insert serves the functions of both supplying fluidizing agent and cooling the reactor, a separate cooling device for the reactor vessel is unnecessary, or it becomes unnecessary to line the reactor vessel with refractory clay, respectively. This allows to obtain a reactor vessel having low thermal masses, a compact design, and increased power density.

In accordance with the advantageous aspect of the invention according to claim 2, the insert is exchangeable and may therefore be disassembled and replaced in a simple manner as an expendable part.

In accordance with the preferred embodiments according to claims 3 to 4, the insert is pipe-shaped and is adapted to the shape of the column-type reactor vessel. Due to this adaptation, cooling of the reactor vessel wall is optimized.

Due to the advantageous aspect of the invention according to claim 5, the insert is subjected to a homogeneous thermal load over its cross-section. Deformations due to different thermal loads are hereby avoided.

In accordance with the advantageous aspect of the invention according to claim 6 or claim 23, the jacket of the insert is made up of metallic sheets which are welded by laser and deformed hydraulically (hydroforming). Channel routing of the at least one flow channel may be designed with complete freedom thanks to laser welding, and the subsequent hydroforming results in the formation of a sufficiently narrow air gap to ensure a sufficient gas-gas heat transmission. The jacket thus produced does not have any leakages, and the gap width may be adjusted in a desired manner by means of the hydroforming. Random air paths between the metallic sheets of the jacket may be created with the aid of the laser welds. The low gap widths and periodical deflections, for example at spot welds, create high heat transmission coefficients between the fluidizing agent conducted in the flow channels, in particular air, and the fluidized bed.

Due to the advantageous aspect of the invention according to claim 7 or claim 24, the fluidizing agent may be pre-heated in several flow channels in the insert while at the same time the reactor vessel wall may thus be cooled, and may be supplied in a defined manner into the fluidized bed in several locations distributed over the circumference of the insert for fluidization of the fluidized bed, and may be supplied into the free space above the fluidized bed for complete combustion.

Due to the advantageous aspect of the invention according to claim 8 or claim 25 it is possible to form a plurality of separate flow channels having a smaller number of welds in the insert.

In accordance with the advantageous aspect of the invention according to claim 9, a thermal insulation additionally reducing the thermal load on the reactor vessel wall and thermal losses is disposed between the supporting reactor vessel wall and the insert.

Due to the advantageous aspects of the invention according to claims 9, 10 and 11 or 26 and 27, the required cooling capacity having to be furnished through the fluidizing agent flowing in the insert is reduced. Thus, the temperature of the fluidizing agent may be optimized more easily with regard to its primary function of fluidizing the fluidized bed. In addition the thermal load on the insert is reduced, resulting in a longer service life thereof.

The aspects of the invention according to claims 12 to 14 represent preferred aspects, for thermal loads are very high in fluidized bed combustion systems and in fluidized bed gasification chambers for the production of combustion gas.

Due to the advantageous aspect according to claim 15, the thermal load on the reactor vessel wall is screened both by the fluidized bed combustion chamber and the fluidized bed gasification chamber.

The advantageous aspect of the invention according to claim 16 results in a particularly compact design for the reactor.

Due to the advantageous aspect of the invention according to claim 17, the waste heat contained in the flue gas from the fluidized bed combustion system is utilized for pre-heating the fluidizing agent.

Due to the advantageous aspect of the invention according to claim 18, both primary air and secondary air or fluidizing agent is suitably pre-heated in the metallic jacket of the insert and introduced into the fluidized bed in an appropriate location. Hereby the fluidized bed may be influenced in a defined manner.

The remaining subclaims relate to further advantageous aspects of the invention.

Further details, features and advantages of the invention become evident from the following description of an exemplary embodiment of the invention making reference to the drawings, wherein:

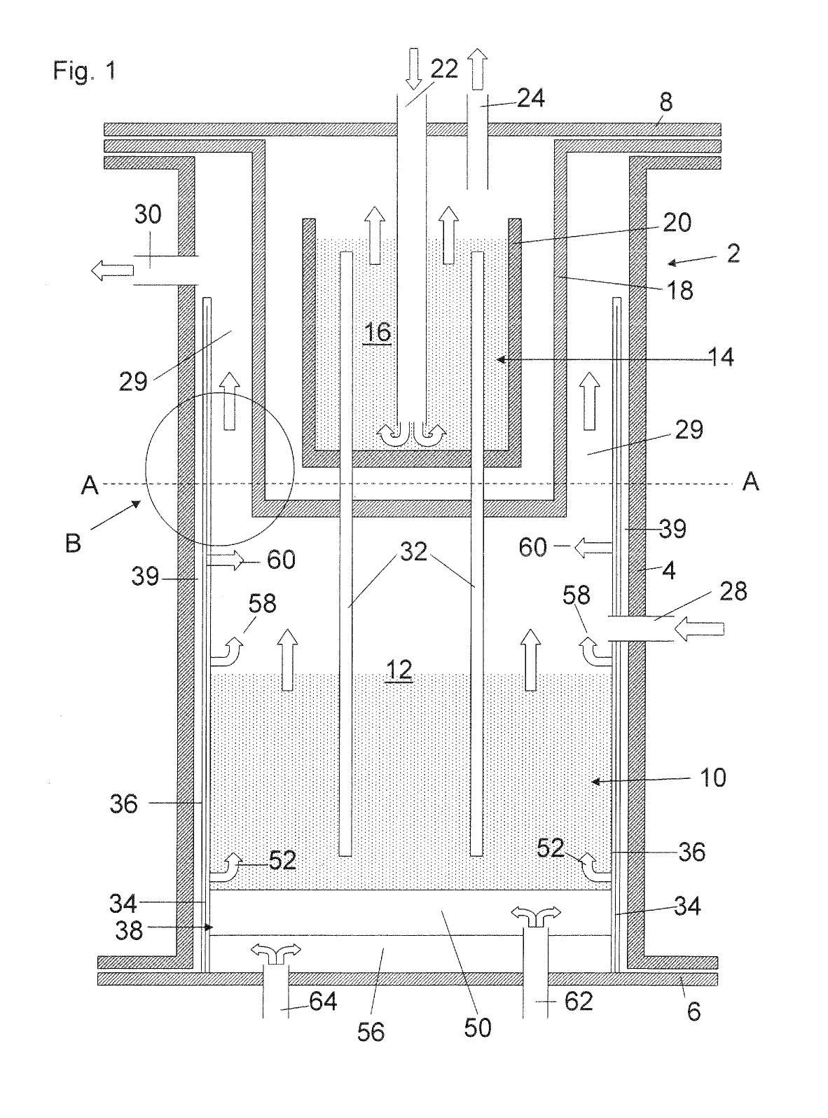

FIG. 1 is a longitudinal sectional representation of an exemplary embodiment of the invention having the form of a so-called heat-pipe reformer,

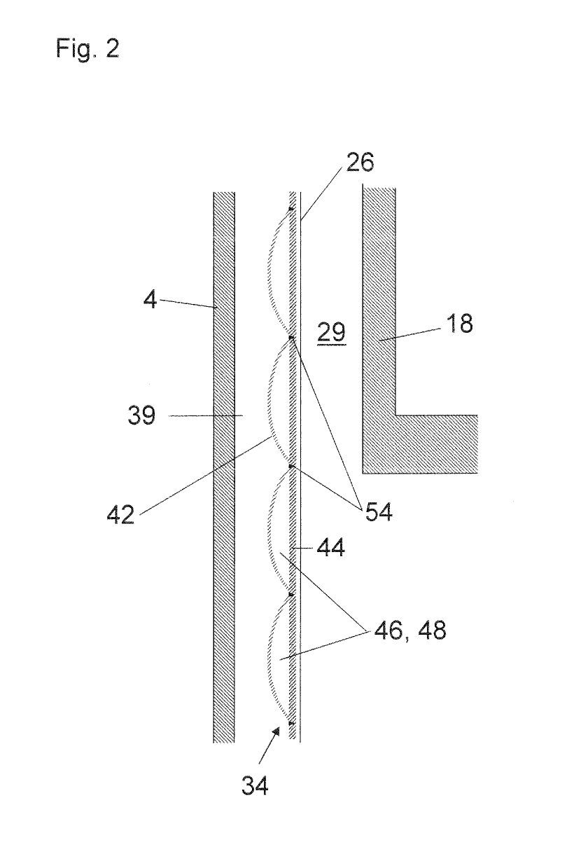

FIG. 2 shows a detail from FIG. 1 designated by B in enlarged representation;

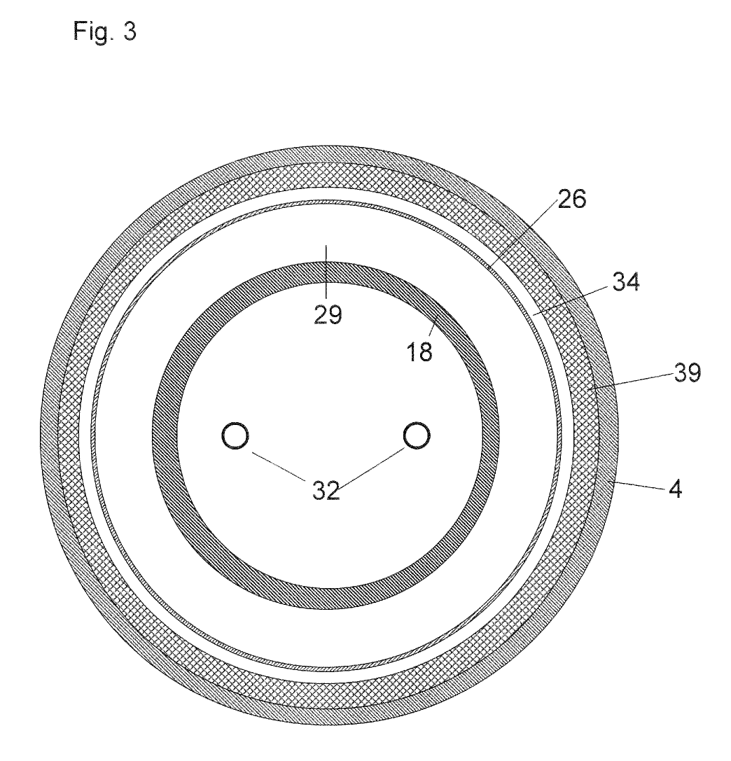

FIG. 3 is a cross-sectional representation along line A-A in FIG. 1;

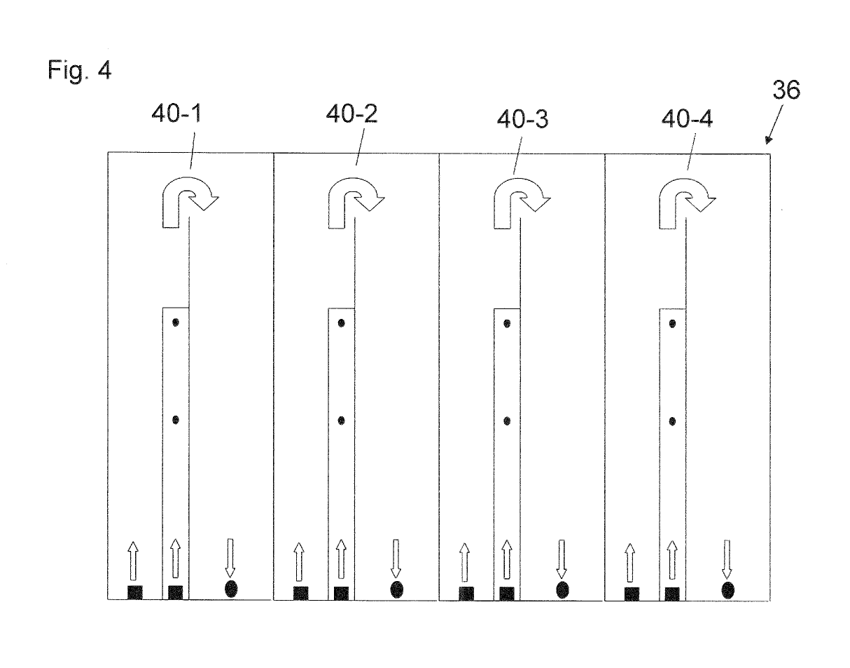

FIG. 4 shows the developed planar view of the circular pipe-shaped insert with four identical flow channel patterns,

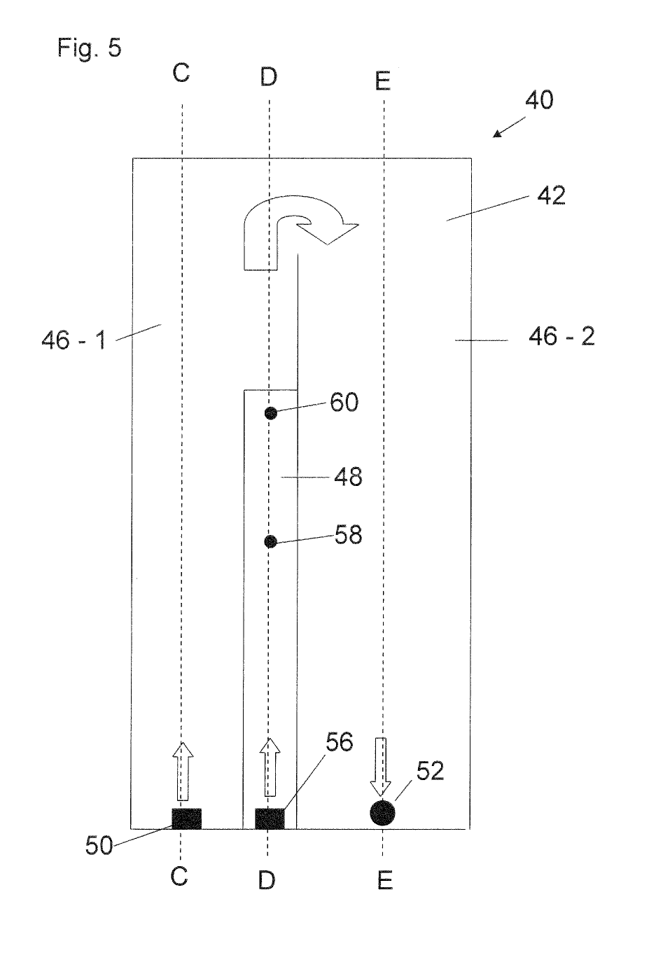

FIG. 5 shows a portion of the developed view according to FIG. 4 with the repeating flow channel pattern in enlarged representation,

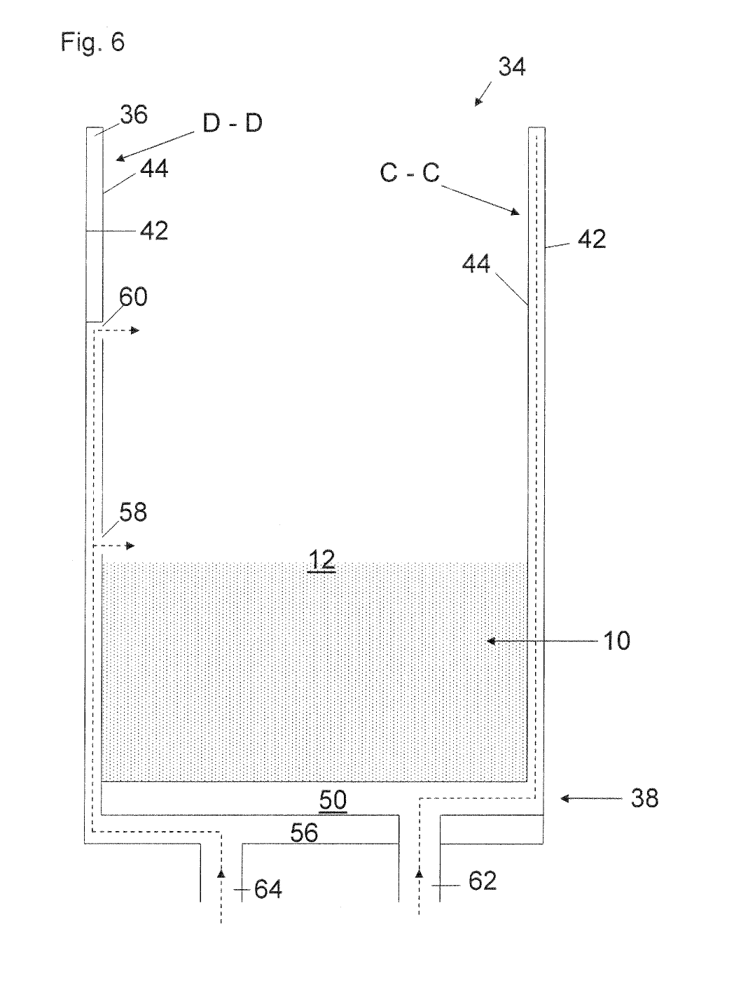

FIG. 6 is a longitudinal sectional representation of the exchangeable insert along lines D-D and C-C in FIG. 5,

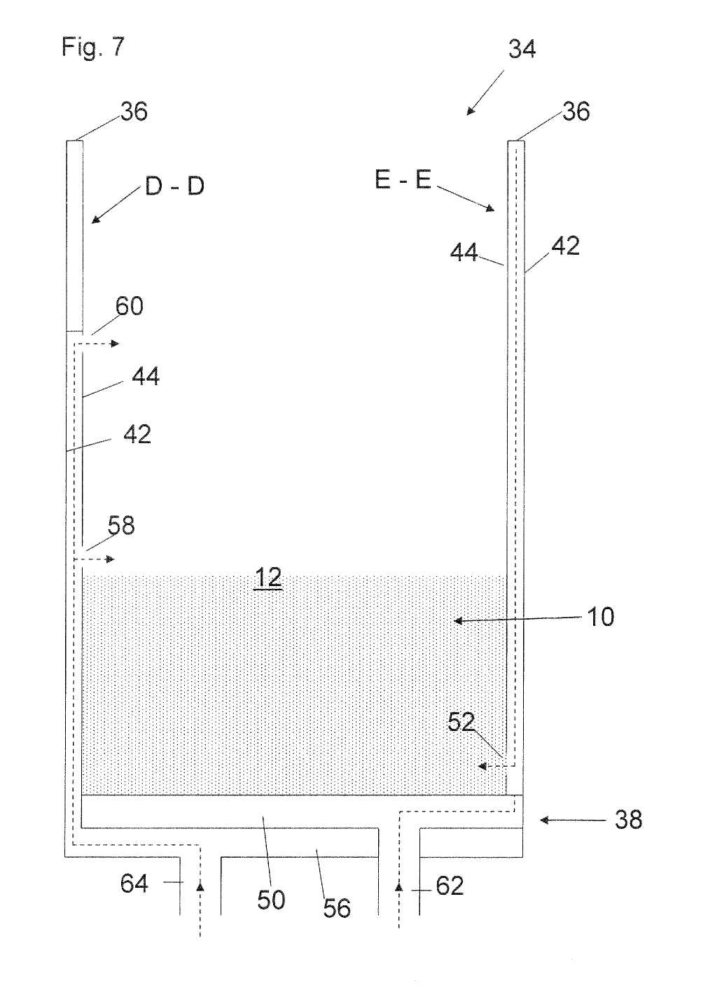

FIG. 7 is a longitudinal sectional representation of the exchangeable insert along lines D-D and E-E in FIG. 5, and

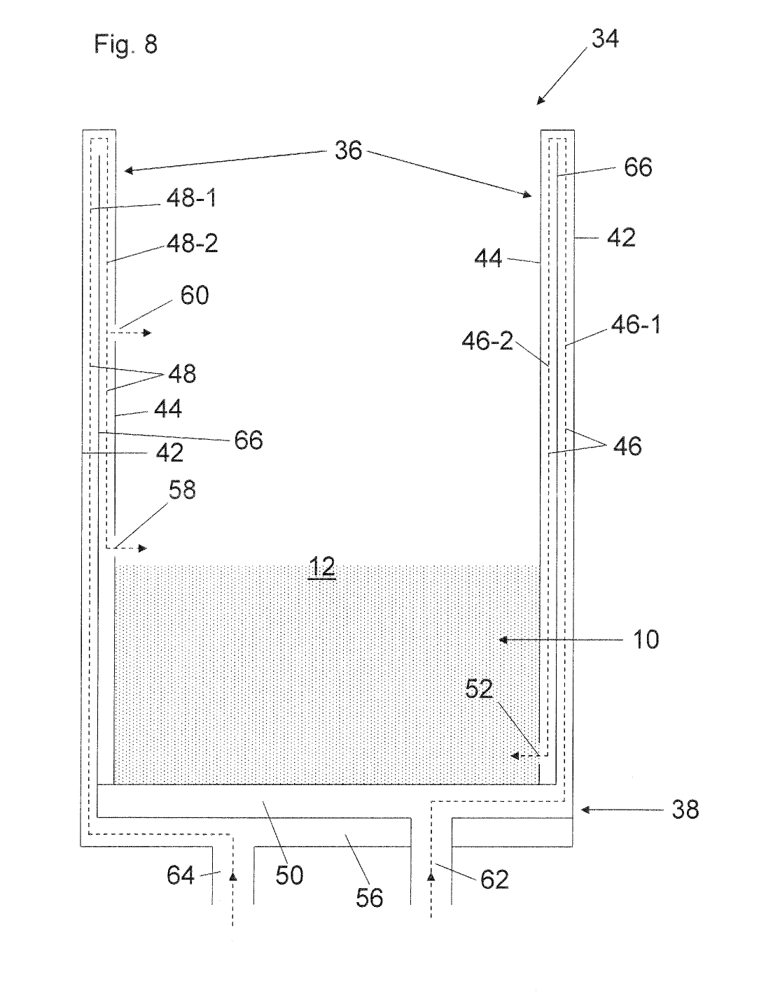

FIG. 8 shows an alternative aspect of the insert.

FIG. 1 shows a longitudinal sectional view of a heat-pipe reformer having a circular-cylindrical reactor vessel 2 which comprises a reactor jacket 4, a floor plate 6, and a cover plate 8. FIG. 3 shows The reactor vessel 2 is made of steel. In the lower part of the reactor vessel 2 a combustion chamber 10 including a fluidized bed combustion system 12 is arranged. In the upper part of the reactor vessel 2 a fluidized bed gasification chamber 14 including a gasification fluidized bed 16 is arranged. In the gasification fluidized bed 16, combustion gas is produced from carbonaceous feedstocks through allothermal steam gasification at temperatures around 800° C.

The fluidized bed gasification chamber 14 includes a circular-cylindrical reformer pressure vessel 18 which is closed by the cover plate 8. Inside the reformer pressure vessel 18 a pot-shaped fluidized bed vessel 20 is arranged which is open at the top and wherein the gasification fluidized bed 14 is formed. From the top through the cover plate 8 a feed means 22 leads into the floor area of the fluidized bed vessel 20. With the aid of the feed means it is possible to introduce carbonaceous feedstocks into the gasification fluidized bed 16. Through the cover plate 8 a combustion gas outlet 24 opens to the outside of the reformer pressure vessel 18. Fuel is supplied via a fuel feed 28 into the combustion chamber 10 or the fluidized bed combustion system 12, respectively. The flue gas from the fluidized bed combustion system 12 is supplied via an annular gap 29 between the jacket 36 and the reformer pressure vessel 18 to a flue gas escape 30. By way of the flue gas escape 30 the exhaust gases of the fluidized bed combustion system 12 are evacuated from the combustion chamber 10 in the reactor vessel 2 to the outside. The heat generated in the fluidized bed combustion system 12 is transferred into the fluidized bed gasification chamber 14, or into the gasification fluidized bed 16, by means of a thermoconducting pipe arrangement 32. In this way the energy required for the production of combustion gas is coupled into the gasification fluidized bed 16.

Along the reactor jacket 4 there extends a pot-shaped insert 34 having a circular ring-shaped cross-section, as may be seen in FIGS. 1 and 3 and from the detail representation in FIG. 2. The pot-shaped insert 34 includes a jacket 36 having a circular ring-shaped cross-section—see FIG. 3—and a circular round floor area 38. The lower area of the pot-shaped insert 34 represents the combustion chamber 10 in which the fluidized bed combustion system 12 is formed. The jacket 36 extends upward as far as the flue gas escape 30, so that the reformer pressure vessel 18 is also enclosed by the jacket 36 up to about ⅔ of its height. Between the reactor jacket 4 and the jacket 36 of the insert 34 a thermal insulation 39 in the form, e.g., of micro-porous silicic acid is arranged. The insert 34 includes a thermal shield 26 which is disposed on the inside of the jacket 36 and has the form of a sheet of heat-resisting steel. The insert 34 has a dual function and serves on the one hand for pre-heating of the fluidizing agent air for the combustion fluidized bed 16, but at the same time for cooling of the reactor vessel 4.

The jacket 36 of the insert 34 is made up of four identical jacket portions 40-1 to 40-4, as is represented in FIG. 4. FIG. 4 shows the planar, rectangular developed view of the jacket 36. One of the four identical jacket portions 40 from FIG. 4 is represented enlarged in FIG. 5. Each of the four jacket portions 40 comprises two laser-welded metallic sheets, one outer metallic sheet 42 and one inner metallic sheet 44. Between the two metallic sheets 42 and 44 a first flow channel 46 for primary air and a second flow channel 48 for secondary air are formed by hydroforming. The inner metallic sheet 44 is thicker than the outer metallic sheet 42, so that the outer, thinner metallic sheet 42 is primarily caused to bulge by hydroforming, as is represented schematically in FIG. 2.

In accordance with the schematic representation in FIG. 5, the first flow channel 46 for primary air includes a left and a right flow channel portion 46-1, 46-2. At the lower edge of jacket portion 40 the left flow channel portion 46-1 opens into a primary air manifold 50. The left flow channel portion 46-1 leads upward on the left side of jacket portion 40 and continues into the right flow channel portion 46-2 which again leads downward at the opposite right side of the jacket portions 40, to terminate there in a primary air outlet 52. The primary air outlet 52 opens into the lower area of the fluidized bed combustion system 12.

Between the two flow channel portions 46-1 and 46-2 of the first flow channel 46 the second flow channel 48 for secondary air is arranged. The second flow channel 48 extends rectilinearly upward from the lower edge of the jacket portion 40 to about ⅔ of the height of the jacket portion 40. At the lower edge of the jacket portion 40 the second flow channel 48 opens into a secondary air manifold 56 and encompasses at about ⅔ of its height an intermediary secondary air outlet 58, and at the upper end an upper secondary air outlet 60. Both secondary air outlets 58 and 60 open above each other into the upper area of the fluidized bed combustion system 12.

In both flow channels 46, 48, air deflection spot welds 54—see FIG. 2—are arranged which are distributed over the length of the channels and result in turbulent mixing of the air guided in the two flow channels 46, 48, whereby heat transmission is enhanced. Due to the arrangement of the flow channels 46, 48 in the jacket 36, the jacket 36 is cooled uniformly.

The left side in FIG. 6 represents a longitudinal sectional view of the insert 34 along the dashed line D-D in FIG. 5, and the right side in FIG. 6 represents a longitudinal sectional view along the dashed line C-C in FIG. 5. The left side in FIG. 7 equally represents the longitudinal sectional view along the dashed line D-D, and the right side in FIG. 7 represents a longitudinal sectional view along the dashed line E-E in FIG. 5. As may be seen in FIGS. 1, 6 and 7, the primary air manifold 50 is formed above the secondary air manifold 56 in the floor area 38 of the insert 34. A primary air inlet 62 whereby primary air is supplied opens into the primary air manifold 50. A secondary air inlet 64 whereby secondary air is supplied opens into the secondary air manifold 56.

FIG. 8 shows an alternative aspect of the insert 34 in which an intermediary, third metallic sheet 66 is disposed between the inner and the outer metallic sheets 44, 42. In other words, three metallic sheets 42, 44 and 66 are welded to each other, so that first and second flow channels 46, 48 may be formed by hydroforming between the inner metallic sheet 44 and the intermediary metallic sheet 66 and between the intermediary metallic sheet 66 and the outer metallic sheet 42. The first flow channels 46 each include one outer flow channel portion 46-1 routed between the outer metallic sheet 42 and the intermediary metallic sheet 66, and an inner flow channel portion 46-2 routed between the inner metallic sheet 44 and the intermediary metallic sheet 66. The second flow channel 48 for the secondary air also includes an outer flow channel portion 48-1 which runs between the outer metallic sheet 42 and the intermediary metallic sheet 66, and an inner flow channel portion 48-2 which runs between the intermediary metallic sheet 66 and the inner metallic sheet 44. The fact that the insert is comprised not of two but three metallic sheets that are welded to each other increases the degrees of freedom for routing of the first and second flow channels.

### LIST OF REFERENCE NUMERALS

2 reactor vessel
4 reactor jacket
6 floor plate
8 cover plate
10 combustion chamber
12 fluidized bed combustion system
14 fluidized bed gasification chamber
16 gasification fluidized bed
18 reformer pressure vessel
20 fluidized bed vessel
22 feed means for carbonaceous feedstocks
24 combustion gas outlet
26 thermal shield
28 fuel feed
29 annular gap
30 flue gas escape
32 thermoconducting pipe arrangement
34 insert
36 jacket of insert 34
38 floor area of insert 34
39 thermal insulation
40-i jacket portions
42 outer metallic sheet of 36
44 inner metallic sheet of 36
46 first flow channels (for primary air)
46-1 left flow channel portion of 46
46-2 right flow channel portion of 46
48 second flow channels (for secondary air)
48-1 left flow channel portion of 48
48-2 right flow channel portion of 48
50 primary air manifold
52 primary air outlet
54 air deflection spot welds
56 secondary air manifold
58 intermediary secondary air outlet
60 upper secondary air outlet
62 primary air inlet
64 secondary air inlet
66 intermediary, third metallic sheet of 36

1. A fluidized bed reactor having
a reactor vessel including a vessel wall,
a fluidized bed arranged in the reactor vessel and fluidized by means of fluidizing agent, and
an insert comprising:
a metallic jacket which encloses the fluidized bed and includes at least one flow channel wherein the fluidizing agent is forcibly conducted in the jacket,
wherein the at least one flow channel runs in the jacket and in parallel with the jacket surface,
at least one inlet led out from the reactor vessel for supplying
fluidizing agent into the at least one flow channel, and
at least one outlet which is connected to the at least one flow channel and opens into the fluidized bed.

2. The fluidized bed reactor according to claim 1, characterized in that the insert is exchangeable.

3. The fluidized bed reactor according to claim 1, characterized in that the reactor vessel is column-shaped and has a jacket-type vessel wall.

4. The fluidized bed reactor according to claim 1, characterized in that the insert is pipe-shaped.

5. The fluidized bed reactor according to claim 1, characterized in that the reactor vessel and the insert have a circular ring-shaped cross-section.

6. The fluidized bed reactor according to claim 1, characterized in that the metallic jacket including the at least one flow channel is constituted of laser-welded and hydraulically deformed metallic sheets.

7. The fluidized bed reactor according to claim 1, characterized in that the metallic jacket is constituted of at least two sections having an identical flow channel pattern.

8. The fluidized bed reactor according to claim 1, characterized in that the metallic jacket is constituted of at least three metallic sheets welded to each other and having flow channels formed between them.

9. The fluidized bed reactor according to claim 1, characterized in that the reactor vessel is made of steel, and that a thermal insulation is arranged between reactor vessel wall and insert.

10. The fluidized bed reactor according to claim 1, characterized in that a thermal shield is disposed on the inside of the insert.

11. The fluidized bed reactor according to claim 10, characterized in that the thermal shield is a heat protection sheet of heat-resisting steel.

12. The fluidized bed reactor according to claim 1, characterized in that the reactor vessel includes a combustion chamber having a fluidized bed combustion system.

13. The fluidized bed reactor according to claim 12, characterized by a fluidized bed gasification chamber for producing combustion gas from carbonaceous feedstocks through allothermal steam gasification, which includes a material lock for charging the feedstocks to be gasified.

14. The fluidized bed reactor according to claim 13, characterized by a heat transport means which transports the heat from the fluidized bed combustion system into the fluidized bed gasification chamber.

15. The fluidized bed reactor according to claim 12, characterized in that the insert encloses both the fluidized bed combustion system and the fluidized bed gasification chamber.

16. The fluidized bed reactor according to claim 12, characterized in that the fluidized bed gasification chamber is arranged above the combustion chamber.

17. The fluidized bed reactor according to claim 12, characterized in that the flue gas from the combustion chamber is conducted in an annular gap between the insert and the outside of the fluidized bed gasification chamber.

18. The fluidized bed reactor according to claim 12, characterized in that the insert comprises a first flow channel, the outlet of which opens into a lower area of the fluidized bed combustion system, and that the insert comprises a second flow channel, at least one outlet of which opens into an intermediary area of the fluidized bed combustion system.

19. The fluidized bed reactor according to claim 14, characterized in that the heat transport means includes a thermoconducting pipe arrangement.

20. An exchangeable insert for a fluidized bed reactor according to any one of the preceding claims, comprising
a metallic jacket which encloses the fluidized bed and comprises at least one flow channel for the fluidizing agent,
said at least one flow channel running inside the jacket and in parallel with the jacket surface,
at least one inlet for supplying fluidizing agent into the at least one flow channel, and
at least one outlet which is connected to the at least one flow channel and which opens into the fluidized bed.

21. The insert according to claim 20, characterized in that the insert is pipe-shaped.

22. The insert according to claim 20, characterized in that the insert has a circular cross-section.

23. The insert according to claim 20, characterized in that the metallic jacket including the at least one flow channel is constituted of laser-welded and hydraulically deformed metallic sheets.

24. The insert according to claim 20, characterized in that the metallic jacket is constituted of at least two sections having identical flow channel patterns.

25. The insert according to claim 20, characterized in that the metallic jacket is constituted of at least three metallic sheets having flow channels formed therebetween.

26. The insert according to claim 20, characterized in that a thermal shield is arranged on the inside of the insert.

27. The insert according to claim 26, characterized in that the thermal shield is a heat protection sheet of heat-resisting steel.

28. The insert according to claim 20, characterized in that at least one manifold for fluidizing agent is provided in the floor area of the insert.
